(19) United States
(12) Patent Application Publication
(10) Pub. No.: US 2026/0093609 A1
(43) Pub. Date: Apr. 2, 2026

(54) INTELLIGENT DEVELOPMENT TEST SELECTION

(71) Applicant: XILINX, INC., SAN JOSE, CA (US)

(72) Inventors: Ambujavalli Kesavan, San Jose, CA (US); Kumaraswamy Namburu, San Jose, CA (US); Priyadarshini Vijjigiri, San Jose, CA (US); Aman Rustagi, San Jose, CA (US); Desmond Lobo, San Jose, CA (US)

(21) Appl. No.: 18/901,863

(22) Filed: Sep. 30, 2024

(51) Int. Cl. G06F 11/36; G06F 8/71

(52) U.S. Cl. CPC G06F 11/3688; G06F 8/71; G06F 11/368

(57) ABSTRACT

Systems and methods for dynamically selecting source code development tests using a trained machine learning (ML) model are disclosed. In certain embodiments, a plurality of data features is derived from information indicating a plurality of modifications to a source code repository. Based at least in part on the derived data features, an ML model is trained to identify correlations between the modifications and a plurality of historical source code development test results. Upon receiving an indication of one or more additional modifications to the source code repository, the trained ML model dynamically selects, from a plurality of source code development tests, a subset of source code development tests relevant to the additional modifications.

### BACKGROUND

In hardware design and verification, ensuring the reliability and correctness of complex systems necessitates extensive testing processes. These typically involve running a multitude of regression tests, which validate that modifications to the source code (human-readable instructions that are compiled or interpreted to create executable software or hardware descriptions for digital systems) do not introduce new errors or adversely affect existing functionalities. Typical approaches to regression testing in many development environments involves executing a static set of predefined tests at various stages of the development pipeline. These static approaches, while straightforward, present several significant challenges and inefficiencies.

For example, static test sets lack adaptability to changes in the codebase. As software evolves, different parts of the code are modified, yet the same set of tests is executed regardless of the nature or scope of these modifications. This results in a substantial amount of unnecessary testing, consuming valuable computational resources and extending the time required to identify and resolve defects. Consequently, developers and testers spend considerable time and effort running tests that may not be relevant to the recent changes. The growing complexity of hardware and software systems exacerbates the problem. As the number of tests increases to cover new features and configurations, the resources needed to execute these tests also escalate.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system designed to implement intelligent source code development test selection, leveraging machine learning techniques to dynamically choose relevant source code development tests based on one or more specified source code modifications, in accordance with one or more embodiments.

FIG. 2 illustrates an intelligent test selection process for training and using a machine learning model to dynamically select source code development tests relevant to one or more specified modifications made to a source code repository, in accordance with some embodiments.

FIG. 3 illustrates a development test selection process for dynamically selecting relevant source code development tests using a trained machine learning model, in accordance with some embodiments.

FIG. 4 illustrates an operational routine for dynamically selecting relevant source code development tests using a trained machine learning model, in accordance with some embodiments.

### DETAILED DESCRIPTION

Existing test selection methodologies typically rely on code coverage analysis, where tests are chosen based on the portions of the code they exercise. While this method provides some insights, it is often labor-intensive and requires generating special builds and using coverage tools, which can be cumbersome and time-consuming. Additionally, these traditional methods do not leverage advancements in machine learning (ML) and artificial intelligence (AI) to substantially enhance the efficiency and effectiveness of test selection.

Embodiments of techniques described herein provide a more intelligent, adaptive approach to source code test selection, so as to dynamically identify the most relevant tests based on the specific changes made to the code. Such techniques reduce resource usage, reduce testing time, and improve the speed and accuracy of code defect detection. While specific examples are provided herein with respect to regression testing, it will be appreciated that in various embodiments and scenarios, other testing may be utilized in accordance with such techniques. As non-limiting examples, the techniques described herein may be implemented with respect to a variety of testing types, including: unit testing, to test individual components or units of software to ensure they function correctly; integration testing, to determine whether different modules or components of the codebase work together as intended; system testing, such as to validate an integrated software system to ensure it meets one or more specified requirements; performance testing, to confirm that one or more performance criteria (e.g., response time, stability, scalability underload) are satisfied; security testing, such as to identify vulnerabilities and ensure that the software is secure against one or more attack types; compliance testing, such as to ensure that the software complies with one or more relevant standards and regulations; etc.

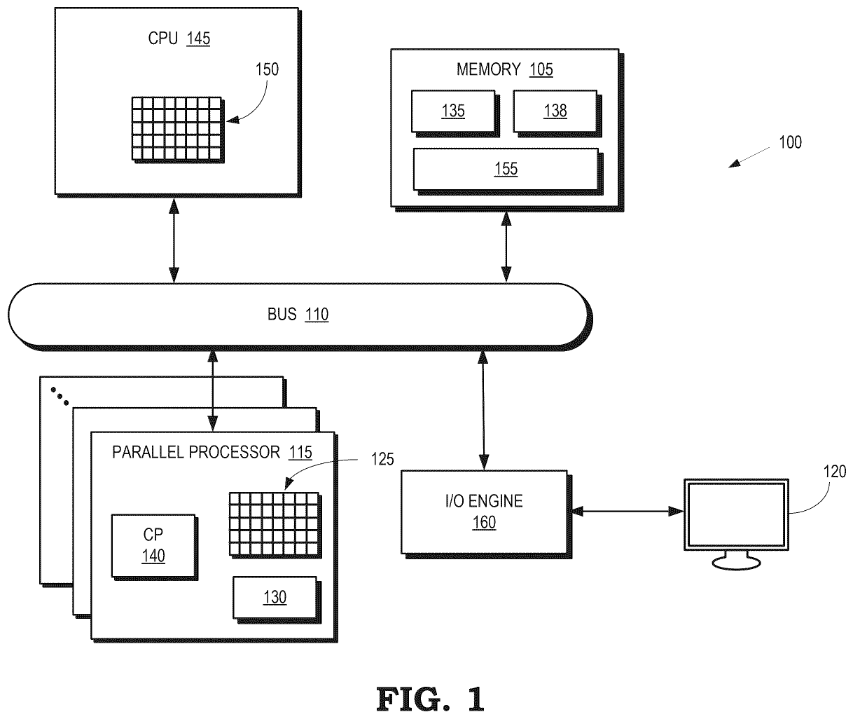

FIG. 1 is a block diagram of a processing system 100 designed to implement intelligent source code development test selection, leveraging machine learning techniques to dynamically choose relevant source code development tests based on one or more specified source code modifications, in accordance with one or more embodiments. The processing system 100 is generally designed to execute sets of instructions or commands to carry out tasks on behalf of an electronic device, such as a desktop computer, laptop computer, server, smartphone, tablet, game console, and the like.

The processing system 100 includes or has access to a memory 105 or other storage component that is implemented using a non-transitory computer readable medium, such as dynamic random access memory (DRAM). The processing system 100 also includes a bus 110 to support communication between entities implemented in the processing system 100, such as the memory 105. In certain embodiments, the processing system 100 includes other buses, bridges, switches, routers, and the like, which are not shown in FIG. 1 in the interest of clarity. In the depicted embodiment, the memory 105 stores a source code repository 155 (generally including human readable instruction code and/or hardware design description code intended to be transformed into computer readable executable instructions), a testing repository 135 (generally including a plurality of source code development tests and related data, such as historical change lists, log files generated during source code development test execution, bug fix data, source code dependencies, etc.), and a historical source code development test results database 138 (generally including historical data related to test outcomes and other results from previously executed source code development tests).

The processing system 100 includes one or more parallel processors 115 that are configured to render images for presentation on a display 120. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 115 can render objects to produce pixel values that are provided to the display 120. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 115 is also used for general-purpose computing. For instance, the parallel processor 115 can be used to execute one or more implementations of one or more convolutional or other neural networks, as described herein. In some cases, operations of multiple parallel processors 115 are coordinated to execute a machine learning algorithm, such as if a single parallel processor 115 does not possess enough processing power to execute the one or more neural networks on its own.

The parallel processor 115 implements multiple processing elements (also referred to as compute units) 125 that are configured to execute instructions concurrently or in parallel. The parallel processor 115 also includes an internal (or on-chip) memory 130 that includes a local data store (LDS), as well as caches, registers, or buffers utilized by the compute units 125. The parallel processor 115 can execute instructions stored in the memory 105 and store information in the memory 105 such as the results of the executed instructions. The parallel processor 115 also includes a command processor 140 that receives task requests and dispatches tasks to one or more of the compute units 125.

The processing system 100 also includes a central processing unit (CPU) 145 that is connected to the bus 110 and communicates with the parallel processor 115 and the memory 105 via the bus 110. The CPU 145 implements multiple processing elements (also referred to as processor cores) 150 that are configured to execute instructions concurrently or in parallel. The CPU 145 can execute instructions such as program code (not shown) stored in the memory 105 and the CPU 145 can store information in the memory 105 such as the results of the executed instructions.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues commands to the parallel processor 115 to initiate processing of a kernel that represents the program instructions that are executed by the parallel processor 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups (also termed thread groups) that are executed on different compute units 125. For example, the command processor 140 can receive these commands and schedule tasks for execution on the compute units 125.

In some embodiments, the parallel processor 115 implements a graphics pipeline that includes multiple stages configured for concurrent processing of different primitives in response to a draw call. Stages of the graphics pipeline in the parallel processor 115 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware-or software-implemented construct in a processing system, such as processing system 100. In various embodiments, such a layer may perform one or more operations via processing circuitry of the processing system 100 to serve as a collection or group of interconnected neurons or nodes, arranged in a structure that can be optimized for execution on one or more parallel processors (e.g., parallel processors 115) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 105) and manipulated by the central processing unit (CPU) 145 and/or the parallel processors 115.

In some instances, such layers may be distributed across multiple processing units within a system. For instance, different layers or groups of layers may be executed on different compute units 125 within a single parallel processor 115, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

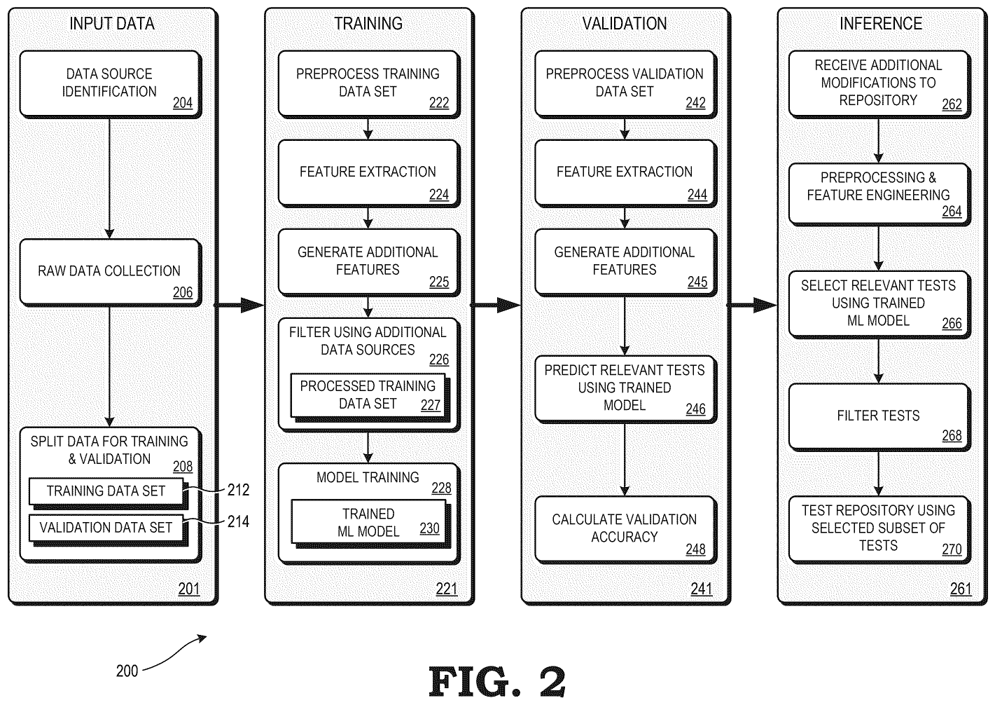

FIG. 2 illustrates an intelligent test selection process 200 for training and using a machine learning model to dynamically select source code development tests relevant to one or more specified modifications made to a source code repository, in accordance with some embodiments. In the depicted embodiment, four distinct phases are utilized: an input data phase 201, a training phase 221, a validation phase 241, and an inference phase 261. These phases and their constituent operations collectively enable intelligent test selection based on one or more source code changes.

The input data phase 201 involves identifying and preparing the necessary data for training and validating the machine learning model. Initially, data source identification 204 is performed to determine the relevant data repositories. In various scenarios and embodiments, such repositories may include historical change lists, test results databases, log files generated during test execution, bug fix data, and source code dependencies. As used herein, a change list or change listing refers to an indication of one or more specified modifications made to a source code repository. In various embodiments, such change lists include information such as commit hashes, file paths, descriptions of the modifications, identifiers of one or more developers who made the modifications, timestamps indicating when the changes were made, and other information describing the one or more modifications to the source code repository.

Following data source identification 204, raw data collection 206 is conducted to gather the necessary information from the identified sources, such as to retrieve historical change lists that document modifications made to the source code over time. These change lists may include, as non-limiting examples, information indicative of details such as commit hashes, file paths, descriptions of changes, and identifiers of the developers responsible for the modifications. In certain scenarios and embodiments, historical source code development test results are collected, which provide data regarding the status of previous source code development tests (e.g., pass, fail, or error), resource usage (e.g., CPU, memory, and time), and the specific test suites to which each such source code development test belongs. This raw data serves as the foundation for subsequent preprocessing and feature engineering. As used herein, feature engineering refers to deriving data features from the raw data, and may comprise both extracting data features from that raw data as well as generating additional data features based on both the raw data and the extracted data features.

In the depicted embodiment, once the raw data is collected, it is split into distinct data sets designated for training and validation (training data set 212 and validation data set 214). This division enables evaluating the model's performance and ensuring its ability to generalize to new input data. In various embodiments, a substantially larger portion of the collected raw data is allocated for training the machine learning model as training data set 212, while a smaller, separate subset is reserved for validation data set 214. This approach ensures that the model can be trained effectively and its predictions can be validated against similar but independent data, providing a reliable measure of its accuracy and robustness.

Once the raw data has been collected and split into training and validation sets, the training phase 221 initiates. The training phase 221 involves developing a machine learning model capable of predicting relevant source code development tests based on extracted features from the collected raw data, as well as on additional features generated based on that raw data. In the depicted embodiment, the training phase 221 comprises the following operations: training data set preprocessing 222, feature extraction 224, additional feature generation 225, filtering using additional data sources 226, performing model training 228, and obtaining the trained model 230.

Initially, the training data set 212 is preprocessed during the operation denoted by preprocessing the training data set 222. In various embodiments, such data set preprocessing involves transforming the raw data into a format suitable for subsequent machine learning processes, and comprises one or more of normalizing numerical values, encoding categorical variables, and handling missing data. Preprocessing ensures that the data is in a consistent and usable state for subsequent steps.

Following preprocessing, feature extraction 224 is performed to identify and isolate relevant features from the preprocessed training data set. This extraction process may involve identifying file types (e.g., determining whether a file is a .c, .h, or .java file), calculating change frequencies (e.g., counting the number of times a file has been modified over the last 30 days), and assessing developer activity (e.g., tracking the number of commits made by a developer within a specified period). These data features are derived from the training data set and provide the foundational inputs for the machine learning model.

In the depicted embodiment, once the initial features are extracted, additional features are generated (generate additional features 225) to enhance the extracted features through various feature engineering techniques. For instance, generating additional features may include creating composite features by combining existing ones (e.g., calculating the weighted impact of changes by considering both the frequency of file modifications and the experience level of the developers who made those changes) and/or deriving new metrics (e.g., assessing the risk level of a change by analyzing the historical failure rates of tests associated with similar changes). These generated additional features improve the model's ability to learn meaningful patterns and correlations between source code modifications and development test outcomes.

Next, the preprocessed training data set is filtered using additional data sources (filter using additional data sources 226). In various scenarios and embodiments, such operations involve incorporating supplementary information that can further improve the quality and relevance of the features. Additional data sources may include bug fix data, source code dependencies, and/or other contextual information that provides insights into the impact of source code changes. Filtering based on these additional data sources helps in refining the features and removing noise or irrelevant data, thereby enhancing the model's performance.

The resulting processed training data set 227 is then used to perform model training 228. During this operation, a machine learning (ML) model is trained to identify correlations between the plurality of modifications and the historical source code development test results. The ML model learns from the training data by adjusting its parameters to minimize prediction errors and accurately capture the relationships between the features and the development test outcomes.

The outcome of the training phase is a trained ML model 230, which encapsulates the learned correlations and patterns from the historical data. This trained ML model 230 is now capable of predicting relevant development tests based on new source code modifications.

Once the ML model has been trained, the validation phase 241 initiates. In the depicted embodiment, validation phase 241 involves evaluating the accuracy and reliability of the trained ML model using the validation data set 214. The processes involved in this phase closely mirror those of the training phase 221, ensuring consistency and reliability in the model's performance assessment.

Initially, the validation data set is preprocessed (preprocess validation data set 242), so as to transform the raw data of validation data set 214 into a format suitable for the machine learning algorithms. Similar to the training data preprocessing 222, in various embodiments such operations comprise one or more of normalizing numerical values, encoding categorical variables, and/or handling any missing data to maintain consistency with the training data set.

Following preprocessing, feature extraction 244 is performed on the validation data set. This step involves identifying and isolating relevant features from the raw validation data set 214, similar to the feature extraction process applied to the training data set 212. Examples of features extracted include identifying file types (e.g., determining whether a file is a .c, .h, or .java file), calculating change frequencies (e.g., counting the number of times a file has been modified over the last 30 days), and assessing developer activity (e.g., tracking the number of commits made by a developer within a specified period).

Once the initial features are extracted, additional features are generated (generate additional features 245). Generating additional features involves enhancing the extracted features through various feature engineering techniques, just as was done with the training data. Examples include creating composite features by combining existing features (e.g., calculating the weighted impact of changes by considering both the frequency of file modifications and the experience level of the developers who made those changes) and deriving new metrics (e.g., assessing the risk level of a change by analyzing the historical failure rates of tests associated with similar changes). These generated features improve the model's ability to learn meaningful patterns and correlations between source code modifications and development test outcomes.

With the validation data set fully processed, the next step is to predict relevant tests using the trained model 246. The trained ML model 230, developed during the training phase, is applied to the processed validation data to predict which source code development tests are relevant to the validation data set's modifications.

The predicted tests are then compared against the actual outcomes to calculate validation accuracy 248, measuring how accurately the model's predictions match the real test outcomes, and thereby providing a reliable assessment of the model's performance.

Metrics such as accuracy, precision, recall, and F1 score may be calculated to evaluate the model's effectiveness in predicting relevant tests. An F1 score is a measure of a source code development test's accuracy that considers both precision and recall, with precision being the ratio of true positive results to the total number of positive results predicted by the model, and with recall being the ratio of true positive results to the total number of actual positive results. Thus, an F1 score is the harmonic mean of precision and recall, providing a single metric that balances the two. An F1 score is typically useful in situations in which both false positives and false negatives are to be considered.

Thus, the validation phase 241 ensures that the performance of the trained ML model 230 is accurately evaluated, confirming its ability to dynamically select relevant source code development tests based on modifications to the source code repository.

After the trained ML model 230 has been validated, the inference phase 261 initiates. The inference phase 261 involves applying the trained machine learning model to new source code modifications, enabling the dynamic selection of relevant development tests based on those additional source code modifications. In the depicted embodiment, the inference phase 261 comprises receiving additional modifications to the source code repository (operations 262), preprocessing and feature engineering (operations 264), selecting relevant source code development tests using the trained ML model 230 (operations 266), filtering the selected relevant source code development tests (operations 268), and testing the source code repository (including the additional received modifications) using the selected subset of source code development tests (operations 270).

Initially, the system receives additional modifications to the repository (operations 262). In certain embodiments, these additional modifications are captured as change lists that document the new changes made to the source code repository, but in various scenarios and embodiments such additional modifications to a source code repository may be documented in other manners and formats.

Following the receipt of the additional modifications, preprocessing and feature engineering 264 are performed on the change lists. This preprocessing involves cleaning and transforming the raw data into a suitable format for the machine learning model, and in various embodiments comprises one or more of normalizing numerical values, encoding categorical variables, and/or handling any missing data to ensure consistency with the training and validation data sets. Feature engineering, as noted elsewhere herein, encompasses both the extraction of relevant features (e.g., identifying file types, calculating change frequencies, and assessing developer activity) and the generation of additional features (e.g., creating composite features and deriving new metrics) based on the raw data and/or the extracted data features.

Once the preprocessing and feature engineering are complete, the trained ML model 230 is used to select relevant source code development tests (operations 266) for the additional modifications. The trained ML model 230 leverages the correlations and patterns learned during the training phase to determine which source code development tests are most relevant to the recent additional modifications to the source code repository. This dynamic selection process ensures that only the most pertinent source code development tests are chosen, optimizing resource usage and improving testing efficiency.

The next operation, filtering tests 268, is performed separately from the trained machine learning model. This step involves refining the selected source code development tests to remove any redundancy and ensure that the test suite is both efficient and comprehensive. This may include eliminating similar source code development tests that do not add significant value or consolidating source code development tests that cover the same aspects of the modified source code. Filtering helps in reducing the testing workload while maintaining the effectiveness of the testing process.

Finally, the system tests the repository using the selected subset of source code development tests (operations 270). The selected source code development tests are executed against the source code repository to validate the additional modifications, ensuring that those additional modifications do not introduce new issues and that the software represented by the source code repository maintains its integrity and functionality.

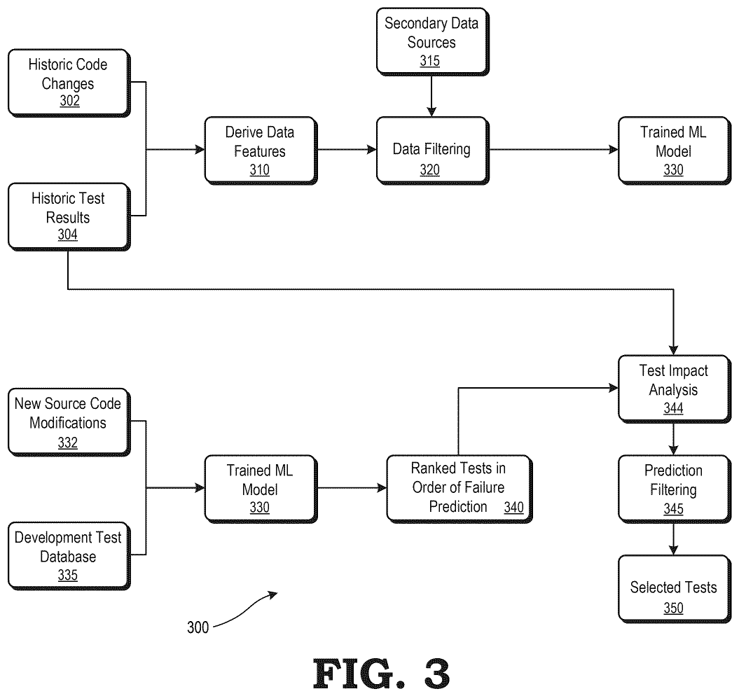

FIG. 3 illustrates a development test selection process 300 for dynamically selecting relevant source code development tests using a trained machine learning model, in accordance with some embodiments. The development test selection process 300 leverages historical data, secondary data sources, and techniques for deriving data features to train the ML model to predict the most pertinent development tests for validating new source code modifications.

Initially, historic code changes 302 and historic test results 304 are gathered; this raw historical data is to provide the machine learning model 330 with a foundation for understanding past modifications and their impact on source code development tests. At step 310, data features are derived. As described elsewhere herein, in various scenarios and embodiments the deriving of relevant data features comprises extracting data features from the raw historical data and/or generating additional data features based on the raw data and on the extracted data features. In certain embodiments and scenarios, these derived data features include, as non-limiting examples: file types, change frequencies, and developer activities, as well as composite metrics like weighted impact of changes and risk levels based on historical failure rates.

Secondary data sources 315 are incorporated into the process during data filtering 320. In this manner, supplementary information such as bug fix data (information regarding previous issues identified and resolved within the source code repository), stack trace data (information about sequences of method or function calls that led to an error or exception), and source code dependency data (information detailing the relationships and interactions between various components or modules within the source code repository) is used to refine and improve the quality of the derived data features. The filtered data is then used to train the ML model 330, resulting in a trained ML model that can predict relevant source code development tests based on new modifications.

For new source code modifications 332, the trained ML model 330 is applied to predict relevant tests. The new source code modifications 332, along with the current development test database 335, are provided to the trained ML model to generate predictions regarding the likelihood that the source code development tests will fail based on the new code changes. The trained ML model produces a ranked list of tests in the order of failure prediction 340, prioritizing development tests that are most likely to identify issues introduced by the new source code modifications.

The ranked tests undergo test impact analysis 344, where the potential impact of the predicted failures is assessed. In the depicted embodiment, impact analysis 344 is also based on the historic test results 304, which aids in determining the significance of the predicted test failures and guides further filtering of the predictions. In the depicted embodiment, during prediction filtering 345, redundant or low-impact tests are removed, thereby refining the list of predicted tests to ensure efficiency and effectiveness.

The final output of this process is a set of selected source code development tests 350, which are chosen based on their relevance to the new source code modifications and their potential impact on the source code repository. These selected development tests are then executed to validate the modifications, ensuring that the new changes do not introduce new issues and that the corresponding executable software or hardware description maintains its integrity and functionality.

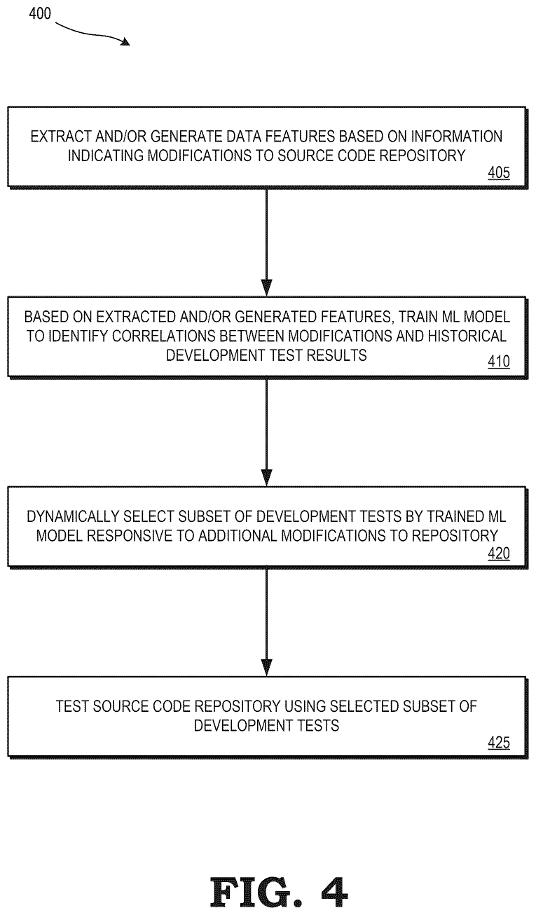

FIG. 4 illustrates an operational routine 400 for dynamically selecting relevant source code development tests using a trained machine learning (ML) model, in accordance with some embodiments. The operational routine 400 may be performed, for example, by one or more embodiments of a processing system such as processing system 100 of FIG. 1.

At 405, the processing system extracts and/or generates data features based on information indicating historical modifications to the source code repository. In various embodiments, this involves both identifying data features within the raw data and deriving additional data features from those identified data features and/or that raw data, including identifying file types, change frequencies, and developer activities.

Additionally, in various scenarios and embodiments composite metrics such as weighted impact of changes and risk levels based on historical failure rates are generated. These derived data features provide a comprehensive representation of the modifications to the source code repository. It will be appreciated that in various embodiments and scenarios, a wide variety of data features may be both identified and derived in order to gain trainable insights into the source code repository and modifications to it.

At 410, the processing system uses the derived data features to train an ML model (e.g., ML model 230 of FIG. 2 and/or ML model 330 of FIG. 3) to identify correlations between the modifications and historical source code development test results. The training process involves using the extracted and/or generated features to develop the ML model, enabling it to learn patterns and relationships between the source code modifications and the outcomes of historical development tests. The trained ML model can then accurately predict which tests are relevant to new modifications.

At 420, the processing system executes the trained ML model to dynamically select a subset of source code development tests in response to information regarding additional modifications to the source code repository. Responsive to the information regarding these new modifications to the source code repository, the trained model evaluates the changes and selects a subset of development tests that are most relevant to the new modifications. This dynamic selection process ensures that only the most pertinent tests are chosen, optimizing resource usage and improving testing efficiency.

At 425, the processing system uses the selected subset of source code development tests to test the source code repository. This step involves executing the selected development tests to validate the modifications, ensuring that the new changes do not introduce new issues and that the corresponding executable software and/or described hardware maintains its integrity and functionality. In certain embodiments, the results of these development tests are subsequently used to further update and refine the trained ML model, enhancing its predictive accuracy over time.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc.

This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, the apparatus and techniques described above are implemented in a system including one or more integrated circuit (IC) devices (also referred to as integrated circuit packages or microchips), such as the systems and techniques described above for dynamically selecting relevant source code development tests with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
training a machine learning model to identify correlations between a plurality of modifications to a source code repository and a plurality of historical source code development test results, the training based at least in part on a plurality of data features derived from information indicating the plurality of modifications to the source code repository;
responsive to an indication of one or more additional modifications to the source code repository, dynamically selecting, via the trained machine learning model and from a plurality of source code development tests, a subset of source code development tests relevant to the one or more additional modifications; and
testing the source code repository using the selected subset of source code development tests.

2. The method of claim 1, wherein deriving the plurality of data features comprises extracting one or more data features from the information, and wherein the extracted one or more data features comprises one or more of a group that includes identifiers of modified files, descriptions of one or more modifications of the plurality of modifications, or identifiers of developers who made one or more modifications of the plurality of modifications.

3. The method of claim 2, wherein deriving the plurality of data features comprises generating one or more data features based on one or more of a group that comprises the information indicating the plurality of modifications or at least one of the one or more extracted data features.

4. The method of claim 1, wherein deriving the plurality of data features comprises deriving the plurality of data features based on one or more source code change lists.

5. The method of claim 1, further comprising validating the trained machine learning model by assessing an accuracy of the trained machine learning model using a selected portion of the information indicating the plurality of modifications.

6. The method of claim 1, further comprising, subsequent to testing the source code repository using the selected subset of source code development tests, updating the trained machine learning model to reflect one or more test results from the selected subset of source code development tests.

7. The method of claim 1, wherein the source code repository comprises a hardware design description repository.

8. The method of claim 1, wherein the plurality of historical source code development test results comprises information indicative of test outcomes and/or resource usage metrics associated with previous executions of one or more source code development tests of the plurality of source code development tests.

9. The method of claim 1, wherein training the machine learning model comprises filtering a training data set for the machine learning model based on one or more secondary data sources, the one or more secondary data sources comprising one or more of a group that includes bug fix data or source code dependency data.

10. A system, comprising:
a memory to store information indicative of a plurality of modifications to a source code repository and information regarding a plurality of historical source code development test results; and
one or more processors, the one or more processors being configured to:
derive a plurality of data features from the information indicative of the plurality of modifications;
based at least in part on the derived plurality of data features, train a machine learning model to identify correlations between the plurality of modifications and the plurality of historical source code development test results;
responsive to an indication of one or more additional modifications to the source code repository, dynamically select, via the trained machine learning model and from a plurality of source code development tests, a subset of source code development tests relevant to the one or more additional modifications; and
test the source code repository using the selected subset of source code development tests.

11. The system of claim 10, wherein to derive the plurality of data features comprises extracting one or more data features from the information, and wherein the one or more extracted data features comprises one or more of a group that includes identifiers of modified files, descriptions of one or more modifications of the plurality of modifications, or identifiers of developers who made one or more modifications of the plurality of modifications.

12. The system of claim 11, wherein to derive the plurality of data features comprises generating one or more data features based on one or more of a group that comprises the information indicative of the plurality of modifications or at least one of the one or more extracted data features.

13. The system of claim 10, wherein the information indicative of the plurality of modifications comprises one or more source code change lists.

14. The system of claim 10, wherein the one or more processors are further configured to validate the trained machine learning model by assessing an accuracy of the trained machine learning model using a selected portion of the information indicative of the plurality of modifications.

15. The system of claim 10, wherein the one or more processors are further configured to update the trained machine learning model to reflect one or more test results from the selected subset of source code development tests.

16. The system of claim 10, wherein the source code repository comprises a hardware design description repository.

17. The system of claim 10, wherein the plurality of historical source code development test results comprises information indicative of test outcomes and/or resource usage metrics associated with previous executions of one or more source code development tests of the plurality of source code development tests.

18. The system of claim 10, wherein to train the machine learning model comprises filtering a training data set for the machine learning model based on one or more secondary data sources, and wherein the one or more secondary data sources comprises one or more of a group that includes bug fix data or source code dependency data.

19. A non-transitory computer-readable medium storing a set of executable instructions that, when executed by one or more processors, causes at least one of the one or more processors to:
train a machine learning model to identify correlations between a plurality of modifications to a source code repository and a plurality of historical source code development test results, the training based at least in part on a plurality of data features derived from information indicating the plurality of modifications to the source code repository;
responsive to an indication of one or more additional modifications to the source code repository, dynamically select, via the trained machine learning model and from a plurality of source code development tests, a subset of source code development tests relevant to the one or more additional modifications; and
test the source code repository using the selected subset of source code development tests.

20. The non-transitory computer-readable medium of claim 19, wherein to derive the plurality of data features comprises one or more of a group that includes to extract one or more data features from the information and to generate one or more additional data features based on the information and on at least one of the one or more extracted data features.
